(19) United States
(12) Patent Application Publication
(10) Pub. No.: US 2024/0303619 A1
(43) Pub. Date: Sep. 12, 2024

(54) Creation and Management of Creative Content with Intelligent Tracking

(71) Applicant: Asmara Marek, Sebastopol, CA (US)

(72) Inventor: Asmara Marek, Sebastopol, CA (US)

(21) Appl. No.: 18/048,175

(22) Filed: Oct. 20, 2022

Related U.S. Application Data
(60) Provisional application No. 63/270,096, filed on Oct. 21, 2021.

(51) Int. Cl. G06Q 20/12; G06Q 20/36

(52) U.S. Cl. CPC G06Q 20/1235; G06Q 20/36; G06Q 2220/00

(57) ABSTRACT

This system provides platforms to manage both the creation and distribution of creative content through a distributed ledger that encodes both the unique creative asset on a blockchain and the contracts of the creators and shareholders for said product. The platform allows creators to make and join projects, manage the production aspects of the project, organize the legal documents and permissions, and conclude the project with payments and a finished product. The apparatus additionally allows for creators and investors to accrue capital in the company through an allocation system that encourages the capitalization of creators. The management system allows creators to work on projects and track ownership to receive residuals on subsequent sales. All creative content whether individual or group, physical or digital, live recorded performance or any other artistic creation can associate the work with a code to create an original or authorized copy to distribute.

This application claims priority to U.S. provisional patent application No. 63/270,096, filed on Oct. 21, 2021, which application is hereby incorporated by reference in its entirety.

Previously due to technological constraints, film and media production has been restricted to a smaller number of creators on in-house contracts to large studios that controlled the output and market of their products. Smaller creative producers outside of the studio system have struggled to find a place in the market as the major studios engaged cinema chains in exclusive distribution contracts thus shutting out smaller producers from most distribution channels. Technological advancements in recording hardware and online media distribution platforms have since developed and become more accessible to everyday consumers thus more “at-home” creators have access to produce digital media work and to monetize their work through advertising residuals. However, the organizational software they need to produce their work is inadequate and/or non-existent. Certain websites offer piecemeal services, but it is only the old-style brick and mortar studios that offer all of them in one package and this model is not sufficient to serve millions of creators as it is not scalable and was created to serve a different market distribution strategy. The approach detailed here is scalable and has global reach. Other companies offer selected piecemeal services, for example, a website offers film and tv users for hire, another software package offers budgeting, another some project management for studios, and finally one offers financing solutions using the blockchain. There is not a combination of bundled services for creative production of the type disclosed herein, nor one that links the creative output both to its production process and to the contracts on a decentralized ledger.

The solution here is a computerized method executing instructions to a mobile and web application that will provide creators with the autonomy they need to both produce work and earn residuals from their work with either minimal or no intercession from third-party mediators in the form of managers, lawyers, and/or agents. The method detailed herein manages all aspects of creative production including creating a project, finding and selecting collaborators to form teams, communicating with the team and assigning tasks, paying collaborators, forming and executing legal agreements, organizing scheduling and budgeting of the project, executing payments, formatting the digital result and or creating a digitized contract for a physical creation embedded with the contracts. The designed use is for creative projects but it can be used for any team project involving freelancers, although it is specifically designed and marketed for those creating film, dance, design, music, theatre, architecture and all other creative projects. Independent creators here are defined as those who use their skills in construction, programming, storytelling, design, and other skills to construct a project, such as a video, performance, audio product, installation, visual product for the purposes of distribution and/or public or private exhibition and/or sale.

The solution provides the ability to track investments in a project and to export the produced product as a blockchain file included therein with a record of important contracts. This solution differs from others because contracts, as in traditional studio work, are agreed upon before the initiation and/or completion of the creative project. Contracts are all agreements related to the payment of the work provided and the percentage of ownership and residuals and/or investment percentages decided upon prior to the initiation and/or completion of the given project. The final project is then encoded along with the prior agreed upon contracts and embedded along with it. Therefore, no ‘original’ and/or ‘authorized’ and/or ‘unique’ product will be distributed without the encoded information regarding intellectual property and creative share ownership. This solution limits disputes regarding creative intellectual property rights as all parties have the record of agreement prior to initiation and limits fraudulent profiteering as all digital ‘masters’ (meaning one unique product) and/or authorized ‘copies’ (such as a video shown on multiple distribution platforms) mark the residuals that are owed the creative authors, shareholders, and other investors/stakeholders.

This method is a combined project management software and communication platform with integrated payment structure designed specifically for artists and creatives, aka “creators,” to manage projects from concept to finished product. All contracts will be recorded as a series of “smart contracts” featured on a blockchain as a record of intellectual property; additional information contained therein will include former investments and other critical information for the engagement and execution of future sales of the project (for example, royalty fee allocation, prior investment liquidation preferences, intellectual property contracts, and other fees necessary for terms of distribution and resales). An internal blockchain token will also be created to manage transactions within the site in order to compensate for a volunteer aspect of time spent on projects for students and amateurs, mentorship compensation for time donated by professionals to assist students and amateurs, and the performance level of tasks executed that can be traded for services within the site, application and other company created software platforms.

This embodiment solves a problem of organizational management for creative teams and projects. This multi-faceted solution streamlines the friction of creative collaboration and creates a virtual studio space to interact, solve problems, and produce collaborative creative work, including visual and audio-based media. Currently, particularly for long-length feature film and video content, the market is dominated by large studios, however with the growing advent of freelancers working through online platforms and uploading content themselves there is a massive gap of services for creators that mimics what a large studio offers for a small number of professional creatives they have on contract. The solution detailed here offers the services of a large in-house studio formerly designed for a few creators on contract but innovates this model to serve millions of creators around the world using online digital platforms and recent technological developments in communication and media sharing. This solution goes a step further, however, by including a decentralized system for financial compensation to protect creators from exploitation and high fees associated with creative work that previously was siphoned to middle managers such as talent agents, legal advisors, and other managers, as well as significantly reduce the costs associated with retaining residuals from distributors.

What was traditionally known as “film,” so named for the celluloid on which the visual and auditory data was recorded upon and now is used as a colloquial term to refer to “the moving image” also associated with “sound” and with the advent of new cinema houses can also incorporate other senses such as movement, olfactory, haptics etc. For the purposes of this discussion, we use “film” to refer to the seventh art, which incorporates ALL of the traditional arts such as drama/theatre, visual, music, architecture, sculpture and dance. Film is the most complex art or creative project from an organizational point of view because of the sheer number of experts and skills involved in its creation, therefore provides a logical basis for the creation of this platform, however the platform is designed to be used for ALL of the arts, including but not limited to theatre, dance, group mural projects, installations, gallery exhibits, music production etc. New forms of digital art simply continue the traditional forms in new distribution platforms, such as the non-fungible token, which can be said to create a digital master but beyond this is essentially a digital output of information that was previously encoded on a DVD and before that on an analog “record.” However, innovation or changes in the nature of the concept of “visual art” have not changed, only that the “visual art” is created on a computer with digital “paints” by a creator, or even today by the computer itself using programmed artificial intelligence. For the point of view of this platform, essentially, serving the creation go “film” conceived here as a visual product incorporating sensory elements including but not limited to sound, movement, haptics, olfactory and other elements of the senses for the purposes of sharing and performance including in-person and remote. Essentially by serving the most organizationally complex creative product here conceived of as “film” the platform can serve all of the arts. “Film” utilizes expertise from all of the traditional arts including set design, dance, music, visual design, sound etc. even as the contemporary manifestations today use digitalization and new forms of production and creation.

Existing team-based platforms and those created for collaborative team work are not sufficient to serve the interests of creators during production and are only useful for the computer-based stage known as post-production which loses crucial information from the pre-production stage. Our integrated solution carries over information from each of these critical creative stages: pre-production, production, and post-production. Pre-production is the stage of selecting and developing the project and includes the selection and development of the “script” or “concept” (for creative work in general), the general outline of the project and includes the selection and hiring of the main creative partners. In the industry these are known as “above-the-line” costs, such as the main “stars” or main “talent,” the scriptwriter, the director, and in some cases the central “cinematographer” and sound. “Below-the-line” costs in terms of crew refers to the visual team that works under the main “cinematographer” such as the grips, the focus puller, the gaffers etc. and this principal works for the sound section or department, the directing section (with the 1st AD or Assistant Director, 2nd AD etc).

This platform solution manages the hiring and contracts for these teams as well as creates a nested structure for the communication and management within each department for communication purposes during production. Production is the stage of the actual creative production of the said creative work: this would be construed as the documenting and recording of the actors in real-life recording or the creation of the drawings by hand or computer for animation, or the “painting” of the mural whether by hand or computer, or the recording of the musical product in a recording space or other lived environment including but not limited to the outdoors. The platform creates a schedule and lists for the participants and/or collaborators needed for the stage of the production, divided up into months, weeks, hours, days or years ow whatever the time structure is to complete the project.

Post-production traditionally takes place by computer in offices or other such studio designed spaces or “houses.” Post-production is both a creative and economic phase, where payments which have not been executed during production are executed, and visual images and sound are “cleaned” and mixed or integrated into a wholistic creative product in one piece or in parts, such as a final product that has different versions or clips or another piecemeal distribution. Oftentimes, post-production involves a relapse into the production stage when missing scenes or items are re-recorded ore redone for the purposes of executing a high-quality output. Sometimes the recording of voice-overs or other sound and visual elements are scheduled after the production for ease of organization. Post-production also includes the alteration or addition of dramatic and thematic elements into the creative product such as the digital enhancement or addition of images and sounds to further develop the product.

The embodiment delineated herein is a computer generated system either online or offline, either by web or mobile or standalone computer system organized around collaborators and projects. Each collaborator and project admitted to the platform is approved by the site administrator. A collaborator can then register a project as a project leader and approve other collaborators to their project and assign tasks. Both the project leader and collaborator agree to the fee and or percentage ownership for the service, the length of the task by time and the task. Within each project there are threads created by the project leader for tasks needed to complete the project providing a topic area where the collaborators can share text, images, links and video related to the task. Specifically for video and theatre production there is an import option to integrate scripts into the system, parse information from it, and organize a schedule and budget around the script. It is also possible to create a schedule and budget for the project without a formal script. A schedule is created based on the time restriction i.e. number of days it takes to execute the project which is variable and can change based on the project requirements, the availability of collaborators and the limits set by the project leader around the financial budget. All elements are adjustable to give the creator the flexibility to choose length of the production according the budgetary and time constraints of the collaborators (this is the “puzzle” traditionally worked out by a “line producer”). The platform determines that the finances are in place for the production by the project lead in order to commence production and protect the financial interests of the collaborators. Once production commences the project leaders approves payouts to the team. The site also provides legal releases in the case that location permissions and/or audio and visual permissions are needed as well as production insurance. All contracts are recorded on a blockchain specific to each project. Investors in the project also have their investments recorded and percentage pay-outs based on the sales agreement. Collaborators who will own shares of the project or who signed IP permissions will also have their contracts recorded on the blockchain. If the result is a digital project the blockchain will also release the project as a unique, original digital product. Within the site an internal token system will be used to determine extra participation, such as volunteering (for students), mentoring (for experts) and high-level work (awarded by project leaders). The unique or authorized copy will encode the contracts so that payouts can be automatically made to the creators into their wallets, and use or distribution without payouts is blocked.

The result and advantages of using this invention for creators are as follows:
1. ability to effectively manage all financial and legal aspects of a given creative project
2. ability to effectively manage communication and team formation of a given creative project
3. ability to effectively organize the schedule and transactions of a given creative project and have financial records to provide to investors, grant making organizations, and tax authorities for earnings.
4. ability to complete the project with a unique electronic record of smart contracts to sell, distribute, and prove share ownership of the project
5. ability to encourage investments in projects as records of transactions are secure and documented and investors have a record of ownership in the event of sales and distribution
6. ultimately saves costs for the creator, increases efficiency to create more projects in less time, ultimately increases ability to earn money off of given projects.
7. protects creators and investors from fraud and from divestment of deserved funds

Any creative production should find the program useful meaning professional producers creating feature digital content, commercials, reality “television,” web series or students and amateurs creating short or long content. Creatives making any and all creative projects either individually or in teams will find this useful for the ability to record products with ownership and investment encoded with the product.

Those producing both digital and physical creative work will find the product useful as a code will be created even for physical originals such as a traditional painting or other 3D artistic object. Previously resales shut out original artists and their inheritors and/or foundations from residuals from resales but this system allows for the encoding of percentage residuals on resales automatically executed to the original author and/or authors and/or entities to which authorship has been assigned. For example, a unique painting is associated with a code and that code matches the blockchain assigned to it with the share allocations including a percentage to the original owner, therefore resales, each and every, compensates the original artist accordingly wherein previously only the previous owner benefited from resales so the artist who may have been of low-market value but later in life or after death is of high market value loses out on the financial advantages inherent in their work. This solution solves that so artists, in life, or even in death, are able to receive residuals due to them and their assigned heirs and/or foundations. The solution can handle multiple stakeholders in a scalable model not limited by number so one, one hundred, one thousand etc for a single or stacked creative product. The basic mechanics of this system works for one stakeholder or multiple.

This method works differently than other devices and processes because it is designed specifically around the flexible structural needs of creative projects. Most project management software is designed for the office environment not for the multiple location sites and freelancer-for-hire requirements of creative projects. Budgeting and financing exist for video and media but are often not tied to communications and management of teams, and the effective budgetary management for creative projects requires this integration of services which this solution provides. A major brick-and-mortar film studio offers all of these services but is not nimble or designed for the use of millions of clients on a digital platform, and is therefore not technologically innovative or designed for wide adoption such as this method.

Since the platform is an integrated multi-use service-oriented website and mobile application clients can pick and choose which services to use, therefore, it can function with partial utilization only. However, it is unique in that it offers all the services of a major traditional studio integrated together on a digital, easily accessible platform. Additionally, the recording of smart-contracts on a blockchain code that incorporates all legal aspects of the production and intellectual property of required participants of a given digital media project into one, unique all-encompassing digital contract is a new feature for the emerging digital media market. Numerous features can be added to make the project work better, including the use of artificial intelligence and data processing to predict client needs and anticipate which services they will need or use. The preferred use is for creative projects but it can be used for any team project involving freelancers, although it is specifically designed and marketed for those creating film, dance, design, music, theatre, architecture and all other creative projects.

The method also includes solutions for the problem of creators going “viral” and receiving no residuals for their images, and ideas or creative work. The author or creator who creates the work on our platform has their image or creation encoded so it can be tracked as it is associated with a specific unique blockchain identifier and reproducibility without the execution of the contracts is not possible.

Participants using the internal token system can exchange them for services within the site but also receive rewards with them for participation in the form of volunteering and mentorship to encourage educational sharing on the platform. Additionally, tokens can be used to purchase shares in the company.

The company incorporates as an operating system the integration of creators as stakeholders in the company that can be earned through participation and exchanges or purchasing of shares through its internal system to create a DAO, or decentralized autonomous organization.

Creators have an ability to automatically divert funds and/or tokens to become owners of shares in the company and gain membership to the DAO.

A secure voting system is accessible within the platform that involves a secure identifier associated with each creator's account that permits the creator to vote on issues affecting the platform. These voting decisions are transparently accessible to the members of the DAO on the secure platform.

Creators earn membership to the DAO through a nomination system, through successful participation in projects, through purchasing shares through the internal tokens, however limits are placed to avoid occurrence of a weighted voting system through purchasing, therefore limits to shares obtained through purchasing which will be decided by the DAO.

Creators thus become stakeholders not only in the projects but in the company. In a capitalist system, economic participants must be holders of not only income but additionally capital, thus this system not only ensures that creators become capital owners of their creative projects but capital owners of the company that creates the creative product as well.

Creators and organizations can contribute CPUs (computer processing units) to aid in the processing power needed for the development of this decentralized ledger system both used to create the creative products with smart contracts and to power the DAO. Creators and organizations registered on the site as contributors and members can earn tokens by contributing CPUs that can be translated into services on the platform and/or shares of the company.

Capital allotments are also recorded on a decentralized ledger or blockchain.

The decentralized ledger or blockchain will use a tiered system, wherein the main decentralized ledger has smart contracts built upon it to limit the gas usage, so contracts regarding share ownerships, voting etc will be built upon the centralized ledger to save on consumption.

This system solves a problem wherein early stage investors who have access to early stage companies end up being financially and capitally over-rewarded for their investments whereas innovators and creators who generated the creative product or inventions are financially and capitally under-rewarded for their inventions, creations, innovations thus encouraging stagnation not further creation and creating a capital imbalance. Investors in this system will also receive capital allocations and rewards but their access and decision-making will be structurally limited so as not to decapitalize the creators by share-dilution through aggressive investing. Thereby a balanced method and system of investing and creation will be formed within the company and this model can be applied to other platforms or companies utilizing a DAO, it is not restricted for use by only this company.

The invention may be better understood by way of the following description that is arranged in Parts A, B, C, D, E and F.

SUMMARY OF PART A: To simply and clearly organize a creative production from the script through curating of the team and deciding on roles, tasks, general timeframes, intellectual property etc everything traditionally thought of as the stage of “pre-production.” This includes but is not limited to a database of creative crew, cast, and suppliers so that a producer or project lead can hire crew, book equipment and services, and manage payments, but also so that crew, cast, and suppliers can apply for film production jobs or contracts. A tiered system is developed so that a project lead can assign another as project lead of a particular department and so on. The platform includes communication and sharing of data related to the development of this stage of the project such as written, visual, sound, and any other information related to the creation of the creative product.

SUMMARY OF PART B: To organize the budgeting, scheduling and payments during the second main phases of a creative production thought of as “production.” To communicate with the team tasked with this stage of the production. This includes all elements of the production including contracts regarding location, access to or the arrangement of food services, trailers, equipment, production insurance, ride-sharing and all transportation, trainers, live and non-live elements such as trained animals, decorations, costumes, any and all aspects traditionally thought of to come under the umbrella of “production” of a cinematic or televisual product but here applied to all creative products.

SUMMARY OF PART C: To create a system for the final stage of the creation of the creative product known as “post-production.” This includes both the creation of the digital product in the last creative stage and the final digital product, both unique and authorized copies. This also includes the financial budgeting and services aspects in terms of payments. This also includes the encoding of the final product on a decentralized ledger and the embedding on it of the smart contracts and the share allocations and payments records. This includes a creative product make either individually or a physical object which will be printed with a code that refers to a blockchain identifier so the creator can receive residuals on resales and tracks ownership and distribution. This includes a unique identifier on an image, text, sound or other unique creative product created by the creator that can spread on the internet and will forever be identified with their work.

SUMMARY OF PART D: To create a system that incorporates a system of tokens or other digital encoding identifier for use on the platform to reward participants or that can be purchased. Rewards can be allocated as the DAO decides but for example: for volunteering on projects or for mentoring those new to the industry by experienced participants, rewards for continued excellent service and/or participation, or for services rendered that benefit the operation of the DAO or the platform. Tokens can be used or exchanged for digital currencies that are approved on the platform. The DAO can decide to use whichever digital system they most trust.

SUMMARY OF PART E: To encourage the capitalization of creators, share allocations can be exchanged and purchased on the platform by members of the DAO, or decentralized autonomous organization that will constitute critical decisions on the operation of the company, thus the participants will operate not as a traditional “union” that competes for wages against the capitalist but as a capitalized union. Membership in the DAO will be established such that trusted collaborators can get access to it and receive capital in the company by accomplished and timely participation. A secure voting platform with decisions recorded on a smart contract that is publicly and securely accessible for the participants will be formed and only creators actively creating will have access to these shares allotments. A separate class system for purely financial investments will be created but these will not be included as main decision members of the DAO but will have access to receive residuals for their financial investments. Thus, a system of the capitalization of creators will be established.

SUMMARY OF PART F: Collaborators have an option to create an online gallery to display and/or sell their work, either digital or physical. The same system of blockchain records will apply here in terms of ability to retain creative ownership over a percentage of their work to be rewarded in the event of resales. A code is provided for physical creative objects.

### SOME TERMINOLOGY

PRE-PRODUCTION involves the development of the entire creative project, but refers to the period before active creation symbolized by the for example, recording of the product, or paining of the product, or programming of the product, we are concerned here with the outline, planning both written, sketched and financial as well as the arrangement and contracts of the sites and crew agreements including permitting, insurances, booking equipment and services etc.

PRODUCTION is the actual creation of the creative product such as the recording in case of a video, the painting of a mural, a dance can be both performed here on in pre-production, and also involves parts of pre-production (hiring new crew, new contracts, new permits) as well as some elements of post-production (already beginning the editing of the product, viewing dailies, rescheduling scenes to be re-shot i.e. returning to the pre-production stage), executing payments, making agreements with suppliers or executing those already made, this stage is both specific and general.

POST-PRODUCTION is when the material is processed usually off-stage but can include a return to stage, recording etc. but involves the final stages of the creation of the creative product and all final financial executions and agreements.

CREW refers to all creatives and technicians hired during a production and includes a range of jobs stemming from set designer to camera and lighting assistants to the costume designers, etc. Certain crew retain intellectual property rights to the work and certain crew do not and this is based on contracts agreed upon during the pre-production stage. However, even if for example, a gaffer or lighting assistant does not retain the visual rights to the work such as the cinematographer they have access to earn capital shares in the company through participation in the DAO, thus all crew (also referred to as collaborators in the text and on the platform) have access to capitalization of the work for themselves and their future heirs.

CAST refers to the actors (whom also may have rights to their image and voice.)

SET refers to the place of the live production.

CREATOR refers to an individual working in the creative industries such as but not limited to art, design, gaming, architecture, drama, theatre, film, video, content creation, music, sculpture, painting, digital art, graphics, dance, installation, writing, and all technological extensions of these arts such as video mapping, 3D modeling etc.

CREATIVE PROJECT refers to any project conceived or created by a creator, that is consisting of but not limited to those related to art, theatre, film, video, drama, dance, architecture, gaming, writing, design, graphics, sculpture, music, in effect those related to or intended to share with the private and/or public sector and including those that create ‘worlds’ or refer to ‘storytelling’ and ‘presentation.’

### DETAILED DESCRIPTION

This invention provides a comprehensive platform to manage both the creation and distribution of creative content through a distributed ledger that encodes both the unique creative asset product and the IP of multiple shareholders (investors, creators, partners) for a given creative asset. The management apparatus allows creators to create and join projects, negotiate payments, communicate critical information to execute the creative content, and manage and track ownership and intellectual property in terms of rights to use and distribute images, sound, and creative IP as well as investor shares and other financial and creative partnerships through a distributed ledger. The ledger records this information directly on the same chain as the created creative asset so that all distributed content contains the ownership agreements and financial information to bypass fraud and allow creators to directly financially benefit from their creative work without the interference of a mediating party. All artistic creation whether individual or group can encode the primary work on a representative distributed ledger that acts as the master and is linked to the physical or digital creative product to track distribution and resales so the original creator listed as an IP owner and their heirs or foundations thereby assigned can reap sales receipts and/or royalties from the creative work as long as the current contract and legal systems permit such collections.

This disclosure describes a system for organizational management of an individual or group creative project that can be defined as a media object, a performance, an audio product, a visual product, an installation or any other product in the creative arts space such as a building, a digital image, a virtual or gaming object, in the realm of the products of human imagination meant to be shared and displayed for general public and/or private consumption.

The platform allows creators to create a profile.

The profile contains an image that represents the creator, a selection of current geographical location or remote, the creative genre the individual participates in (such as architecture, visual arts, sculpture, video, gaming, media arts, etc.) and specific skills (such as proofreading, editing, drafting, ballet, production design, directing, etc), and can post samples of their work including links, video, a slide deck in pdf, and images, and list past or previous work experience.

The platform allows the creator to create a creative project as a project lead.

The project has a name, an image associated with it, a summary or description, a location, a time frame, a creative genre, and skills needed for the project.

The project lead can post video links, a slide deck pdf and/or images associated with the project.

Both the profiles of the creator and the projects are searchable in terms of all entered information, such as name, location, creative genre, skills, past or previous work experience, and all other information entered in searchable terms.

The creator can search for projects in their region, skill set or according to any other preference.

The creator can request to join the project.

The project lead can search for creators in their region, skills needed, indicated time frame, and all other searchable terms to locate an appropriate collaborator.

The project lead and the creator can view the project information and profiles that are listed as public.

The project lead can invite a creator to join the project.

The creator can request to join a project.

The two parties negotiate a fee proposal to join the project or choose a volunteer or mentor mode in which case the parties receive tokenized compensation for mentoring and volunteering as an incentive to collaborate.

The project lead can accept or reject the creator's offer to collaborate.

The creator can accept or reject the project's lead offer to collaborate.

The two parties can renegotiate through messaging and create a new offer if needed.

Once the creator joins the project they are listed as a participant and have access to view other collaborators and the threads.

The number of collaborators is listed at the project.

The project lead can add or remove creators.

Creators can search and join other projects or leave current one, but may risk not receiving payment for not completing tasks.

The project lead can create threads on topics of their choice related to completing the project and chat with all collaborative members.

The project lead can pay creators for participating on the project.

Payments can occur in local currencies, digital currencies, and/or tokens.

Creators can view payments received and made in the payments section.

The platform comprises of a “gallery” or distribution and sales platform for creative products.

Creative work both physical and digital can be shared by creators if they choose in the gallery.

Creative work is either to be viewed only or offered for sale.

Guest visitors and members can view and purchase art or other creative works in the gallery.

Purchases made and pending are viewable in the payments section.

Each creator sets up a digital wallet.

The wallet holds digital currency and tokens used on the platform.

The wallet can be connected to a currency payment platform.

Investors have an ability to view projects, select them, and invest in them and the terms of the investment are recorded on a digital contract associated with the project.

Creators also have an ability to have their input and percentage ownership and intellectual property rights recorded on the chain associated with the project.

Creators can be investors and investors can be creators without creating a separate profile.

The project, whether physical or digital, has a digital blockchain associated with it and all ownership contracts are encoded on it along with the digital version of the creative project (for a digital creation) or a unique code associated with it (for a physical object or live performance or installation).

The blockchain is a decentralized ledger, most likely the most secure being a proof-of-work chain but can be a proof-of-stake chain.

The sale and distribution of the creative product results in automatic payouts to the digital wallets associated with each participant, whether as a creator, a project lead, or an investor or any other participant associated with the project in terms of share ownership and intellectual property.

The encoding of the “smart contract” associated with the project is embedded along with the actual project to circumvent fraud and to ensure all participants receive payouts of their shares.

The information is encoded on a decentralized ledger subject to verification by participating nodes as outlined in the Bitcoin White Paper.

Creators, investors, and or other members of the platform with adequate CPU become part of the node verification system and approve transactions and receive tokens on the platform for their efforts.

Tokens are redeemable on the platform and can be exchanged for services or in some cases for a select digital currency.

Verifications of nodes and contracts on the decentralized ledger are not exclusive to those on the platform, but only those participants on the platform receive the unique tokens of the platform for their processing services rendered.

One implementation of the program is the establishment of creator profiles with information of skills, locations, availability, past work experience, identifying features such as name, handle and image, and samples of work in the form of files such as sound, image, weblink, video etc. The same form for the establishment of a project, with a name, image, description, also a slide deck, video, and any files to communicate information about the project, and skills needed, creative form (i.e. video, music, dance or a combination). This includes functions so that a collaborator or project lead (traditionally known as the producer) imports their script into the program. Most script software programs mark information such as character, prop, dialogue etc. and the platform is compatible with the leading script software on the market. The script holds a number of categories of information such as: location (interior or exterior), costumes, props, day or night shoot, etc. The program identifies all these categories so that the system creates a production schedule and budget. Information will be parsed automatically thus the project lead avoids in most cases having to re-enter information that is already in the script. The platform imports information automatically and is an intuitive option for the collaborator by bridging through to hiring, booking and payments. Collaborators can find and choose projects and collaborators registered as Project Leads can find and choose collaborators. Structures for negotiations of the time, tasks, payment and salaries as well as share contracts are presented for both parties.

Once collaborators are added to the project a communication platforms is provided to communicate and share information about the project. Collaborators can participate in multiple projects simultaneously and can lead multiple projects simultaneously. The Project Lead has access to the most information in order to uses the smart system to create a production schedule that matches the availability and skills of the team according to the scrip requirements. For example, actor A and actor B must appear together in Scene 1 with a blue box. But only Actor A appears in Scene Two this time with a red box. The information on the production plan and budget would be linked, so that if an actor receives X salary per day and the producer changes the actor's shooting schedule from five days to seven, the budget will adjust accordingly. The same will hold for props, costumes, equipment, crew etc. This system applies to any group creative project but also can be applied to an individual project to track payments, equipment, and suppliers and to provide a work schedule.

The production plan will contain all of the important information for the production to occur. For example, which actor, prop, equipment, technician is needed on which day and where. However, during a production contingencies are needed as plans can change, an actor gets sick or a scheduled location is not available and changes to the plan have to be made, sometimes at the last minute. The program will have a mechanism to communicate with crew by text message about their pick-up time (larger productions provide car service) or info about where they should be and at what time. So, the user has made a schedule and the schedule translates the information to send a message to all the crew and cast about their work schedule for the next day. Then, when the user changes the information, the text info adjusts accordingly, and the new information is duly sent out.

A similar system exists for organizing the work flow in the post-production stage which is largely more deck and computer based but can include a return to on-site production.

According to the schedule we have information about which crew is on set and from the budget we have information about how much the labor costs. Also, we should have information about the equipment and items that were booked and rented for the shoot. The program will be able to pay out to the crew and suppliers by having already input the bank details of each worker and supplier. The user/producer can simply review the costs and click at the end of the day or week to send out payments (already linked to the production account) either line by line or all the expenses at once after reviewing. The project lead can assign payment responsibilities to another collaborator assigned to that task. The project lead and any other selected party, such as an investor, can constantly monitor all expenses and the “live” budget as the budget will constantly fluctuate due to the unforeseen changes during the shoot mentioned earlier (the actor is sick, so the production extends a week and new bookings of equipment have to be made etc.) The project lead always has the option to estimate if the shoot goes on for an extra two weeks, costs would go up by X amount, etc.

Payments are recorded on the payments section for each collaborator both those they pay to others, those waiting to go out, those waiting to come in, and those received. Expenditures on the project can be printed to share with investors, grant contributors and other stakeholders.

One implementation of the program connects freelance film crew with producers replacing a film jobs website. Usually, crew members search on job forums for productions in their area and send their resumes directly. Alternatively, currently, producers can either hire freelance crew directly or hire a third-party to hire crew if they are shooting in an unfamiliar location. The system connect s crew with project leads directly. Production crew will create a profile with their photo and films they have worked on and can post their availability to film productions in their area. Project creators can post their projects and available jobs and can review applicants and select for hire, however, the payment and hiring should reside in the program. Payments and fees can also change based on costs in the region, but fees should be fair and clear for both sides.

In some implementations the project lead is to rent production and/or other creative services such as catering, equipment rentals, post-production services etc. with the booking and payments facilitated through the platform.

One implementation of the program is a system to authorize users that are highly active participants on the platform and organize a decentralized autonomous organization (DAO) to make group decisions relevant to the platform.

Authorized members of the DAO have the ability to purchase shares of the platform holding company.

Shares can be purchased through currency, digital currency, or the internal tokens, depending on how the specifics of the system are established.

The DAO has the ability to structure the purchasing power and purchasing system of the share allocation.

A secure voting system for the DAO is one implementation wherein the agenda of the DAO and a method for voting on the decisions is accessible to the members.

A secure platform to discuss aspects of the agenda, and which agenda questions should be voted upon will also be established.

The voting system will include an identifying certificate for the authorized members associated with their account identity to prevent double voting.

Voting is recorded on a secure blockchain using a hash and is anonymous.

The results of the voting are accessible to be viewed by all authorized members.

This implementation is not exclusive to this platform and can be used by other companies and DAOs.

A share allocation and purchasing system with at least two or more classes of share established.

A “creator” level share, whose name is subject to change, will be created with the ability to vote and submit agenda items for the DAO.

An “investor” level share, whose name is subject to change, will be created with the possible ability to vote and submit agenda items for the DAO.

The percentage amount and total ability to purchase shares for the “investor” level will be regulated and subject to limits to prevent the takeover of the company by one investor or an investor conglomerate.

Percentage amounts and total ability to purchase and/or receive shares for the “creator” level will be established as well but will tilt toward the creators as the innovators of new content to retain a weighted power in the DAO.

A system to allocate or direct tokens or other currencies on the site wallets to purchase available shares of the company will be established, similar to the current system of allocating dividends received to repurchase shares.

The share system will be recorded on a blockchain.

The ideal system will be a completely decentralized proof-of-work blockchain with associated contracts attached via a proof-of-stake blockchain to reduce gas fees but ensure a fully decentralized system base with details encoded via smart contracts. This system is subject to fluctuation depending on the changing technologies and the decisions of the DAO on best practices.

Authorized members have the ability to contribute CPUs to the network to gain tokens that can be used to purchase shares or can be traded for another currency.

Companies can also join the platform to offer services that can be obtained via the projects.

Collaborators and companies and guests can have access to the site but not necessarily be authorized members of the platform.

Only individuals can be authorized members of the platform.

The system for authorizing individuals will be subject to change based on prevailing circumstances and decisions of the DAO.

Thus, the computerized method is to manage the development of a creative project, accepting inputs from a first user to establish a creator profile, accepting inputs from a first user to generate a creative project associated with a creator profile, identifying to the first user one or more candidates to provide inputs to the creative project, accepting inputs from the first user to cause one or more payments to be credited to one or more users and issuing the creative project to a distributed ledger in the form of a blockchain.

The blockchain contains not only the project but the contractual agreements related to the project in relation to ownership shares, intellectual property and all other information necessary to establish ownership and rewards in the form of monetary, tokens, digital currencies etc.

The computerized method above further comprises generating a proof-of-work blockchain certificate for the creative project wherein the proof-of-work blockchain certificate includes a proof-of-stake smart contract containing intellectual property and payment information.

The computerized method above identifies another creative project to the first user and accepts inputs from the first user to associate the first user to another creative project.

A computerized method that generates a blockchain identifier for a unique piece of art or physical creation associating the blockchain identifier with a smart contract associated with the author and/or original owner and/or creator so that the creator is able to receive percentage royalties or payments associated with resales and re-distribution of the original piece both for the original sale and/or distribution and/or subsequent resales and/or re-distribution.

The method for the unique art includes authorized copies such as for example those associated with digitized versions of the original piece or in the case of video those as distinguished from the ‘master’ and this applies to written work, image, sound, audio, computer generated and the like.

The conglomeration of the creators in the form of a company will be established using a new form of organization known as a DAO, or decentralized autonomous organization. This conglomeration will allow members of the DAO, to be determined by the DAO, to decide on issues related to the creators and their work and projects and the platform outline herein will create an embodiment of a secure voting platform which issues a voting certificate on a blockchain for an agenda issue, and records the result on the blockchain which is then accessible for the members to check; this blockchain will most likely be a secure proof-of-stake blockchain but can take the form of a proof-of-work block chain.

One embodiment of this platform facilities the creator to transfer tokens, money, currency, and/or digital currency into share ownership of the company; these fractional or full shares are recorded on a blockchain for record keeping and the creators have the option to automatically set purchases with outstanding resources on the platform. Thus, tokens earned, income earner or contributed can be directed to automatically purchase capital shares in the company.

Creators and investors will have different share categories with certain limits placed on investors who receive payments, percentages, residuals as other members but are restricted from purchasing a certain amount to avoid taking over voting share over the creator authorized members to ensure the capitalization of the creators who retain capital ownership over their work and the company.

As a fully decentralized proof-of-work blockchain system requires the use of Computer Processing Units (CPUs), authorized members and others as needed can contribute CPUs to the platform and earn tokens that can be transferred as well into the purchasing of shares of the company and/or other indicated services on the platform.

### BRIEF DESCRIPTIONS OF THE DRAWINGS

FIG. 1a shows various high level aspects of the platform.

FIG. 1b shows various high level aspects of the platform.

FIG. 1c shows various high level aspects of the platform.

FIG. 1d shows various high level aspects of the platform.

FIG. 1e shows various high level aspects of the platform.

FIG. 2 shows various high level aspects of the platform.

FIG. 3 shows various high level aspects of the platform.

FIG. 4 shows various high level aspects of the platform.

FIG. 5 shows various high level aspects of the platform.

FIG. 6 shows various high level aspects of the platform.

FIG. 7 shows various high level aspects of the platform.

FIG. 8 shows various high level aspects of the platform.

FIG. 9 shows various high level aspects of the platform.

The embodiments herein can be implemented in the general context of computer-executable instructions, such as those included in program modules, being executed in a computing system on a target real or virtual processor. Generally, program modules include routines, programs, libraries, objects, classes, components, data structures, etc. that perform particular tasks or implement particular abstract data types. The program modules may be obtained from another computer system, such as via the Internet, by downloading the program modules from the other computer system for execution on one or more different computer systems. The functionality of the program modules may be combined or split between program modules as desired in various embodiments. Computer-executable instructions for program modules may be executed within a local or distributed computing system. The computer-executable instructions, which may include data, instructions, and configuration parameters, may be provided via an article of manufacture including a computer readable medium, which provides content that represents instructions that can be executed. A computer readable medium may also include a storage or database from which content can be downloaded. A computer readable medium may also include a device or product having content stored thereon at a time of sale or delivery. Thus, delivering a device with stored content, or offering content for download over a communication medium may be understood as providing an article of manufacture with such content described herein.

### DETAILED DESCRIPTIONS OF THE DRAWINGS

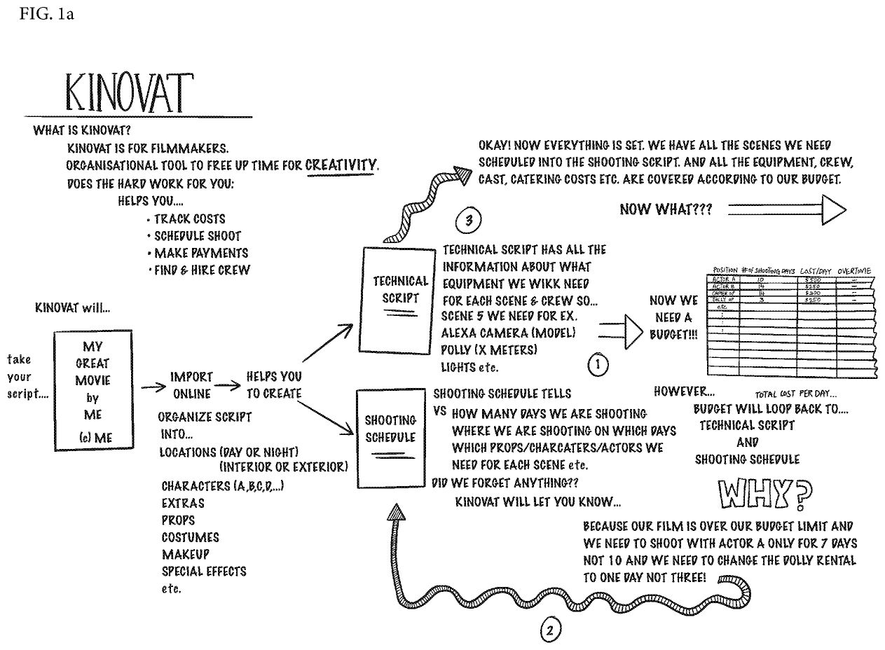

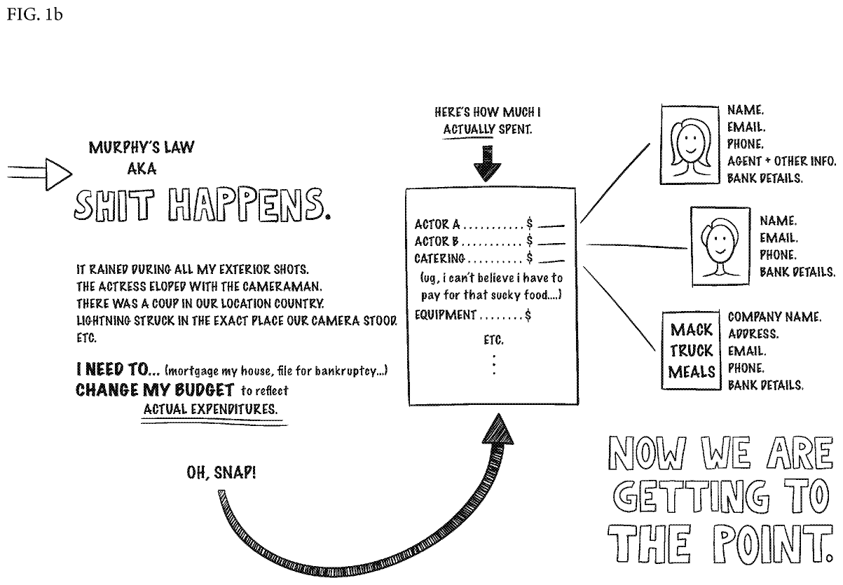

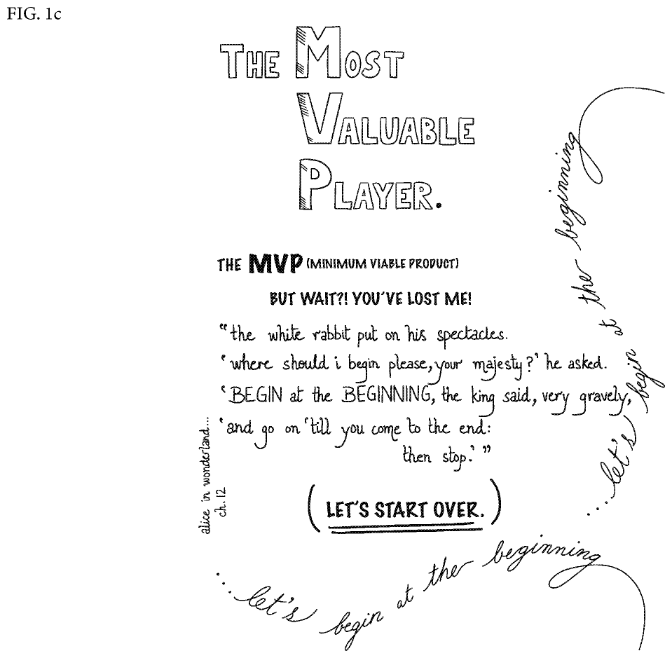

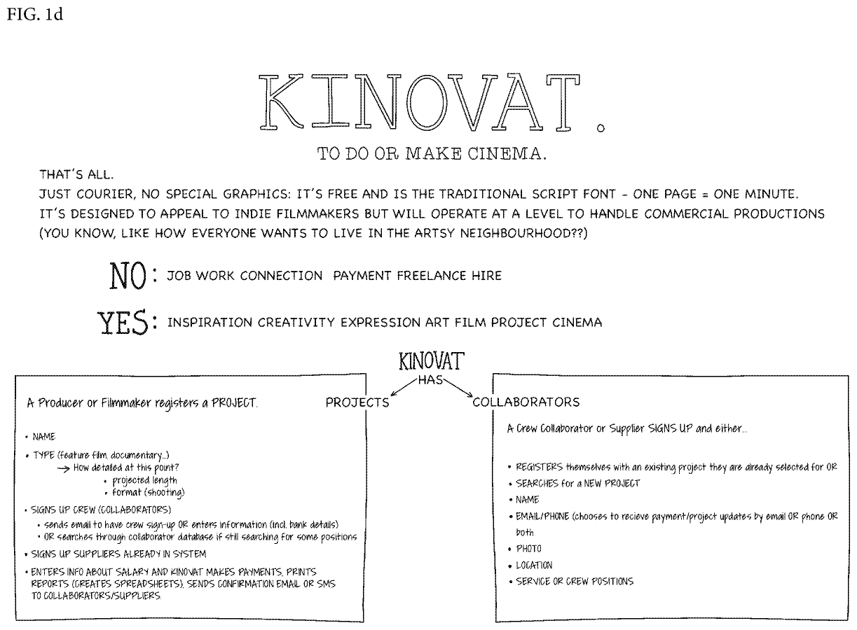

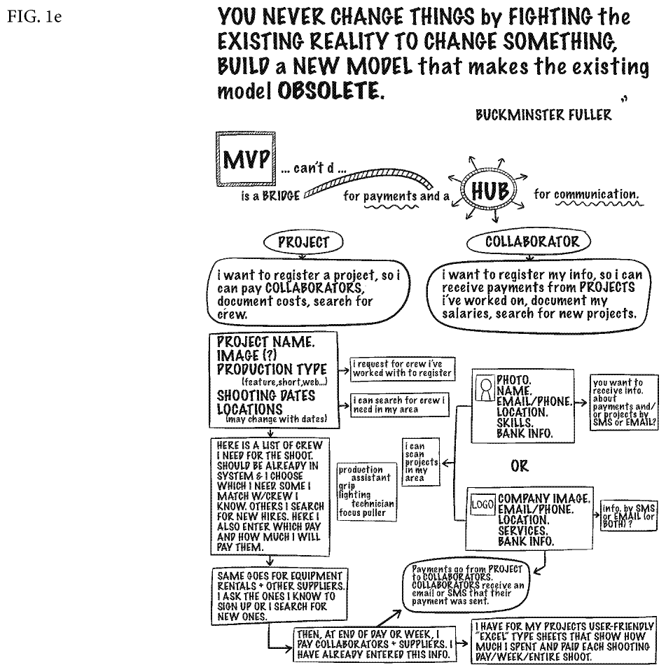

FIG. 1a: This embodiment illustrates the process of software that imports information from a film script and parses out information in the script such as character names, props, costumes, makeup, special effects and creates what is called in the industry a “technical script.” A technical script itemizes exactly who (characters/actors/technicians) and what (props, costumes, locations) are needed for each scene. From the technical script, a “shooting script” is created which divides the scene up into shooting days and organizes scenes grouping them by the availability of actors, locations, costumes and other things needed for the scene (special effects, equipment, trained animals etc.). As every item in the technical scripts is associated with a cost (for example, a trained animal includes the cost of renting the animal, the trainer, and costumes or extras needed for the scene) the costs adjust based on frequency and use of the items and/or people utilized or employed in each scene. Therefore each item is linked with a cost and frequency of use.

FIG. 1b: This embodiment illustrates the adjustability of the shooting script which can change based on real life issues (for example, a scene meant to be shot outside on a sunny day can not take place on a rainy day, therefore the work day is either cancelled or rescheduled for an interior scene which means costs and the schedule will need to be adjusted. An extra day of filming means additional costs associated with renting equipment, paying talent and technicians, insurance, location rental etc. Therefore the budget associated with the project is adjusted as the shooting script and schedule is adjusted and payments for crew and other associated costs is also adjusted.

FIG. 1c: An imaginative illustration quoting Lewis Carroll from Alice in Wonderland that illustrates the concept of continually going back to the original concept, the original script, and updating and developing current needs based on the beginning inspiration.

FIG. 1d: This figure illustrates the intended feeling of the application and proposes some design concepts, for example, using a courier font (a traditional font for film scripts and keeping the stylistic flourishes to a minimum). The design concept has since evolved from these proposals. The “NO” and “YES” indicate the sense of it not feeling like “work,” not being a dry, desktop application but one that encourages a sense of creativity, expression, inspiration, etc. The graphic on the bottom second half illustrates the concept of having a PROJECT and a COLLABORATOR. The PROJECT has information about what type of project it is (a feature film, a commercial, the projected length, technical details), ability to incorporate details linked to the crew such as payment information, any suppliers needed to be linked to the project, and the salary requirements that will also be recorded in a spreadsheet budget. A collaborator and/or a supplier can also register a profile with information such as how to contact them, where they are located, positions they can fill, and a profile photo. Collaborators have the ability to search projects. Project creators can search for collaborators.

FIG. 1e: This embodiment illustrates the needs and requirements for PROJECTS and COLLABORATORS. The PROJECT once registered has a name, image, shooting dates, and locations. The PROJECT can list crew (collaborators) needed for the project (for example, a lighting technician, a focus puller for the camera). A similar model can be set up for suppliers. At a scheduled time the payments which are entered in the program are executed with confirmation by text or email sent to the recipients. The COLLABORATOR can register a profile to receive payments from projects they worked on. The profile has a photo, name, contact information, location, skills, bank information. A company can also create a similar profile. Payments can go from the project administrator to the collaborator.

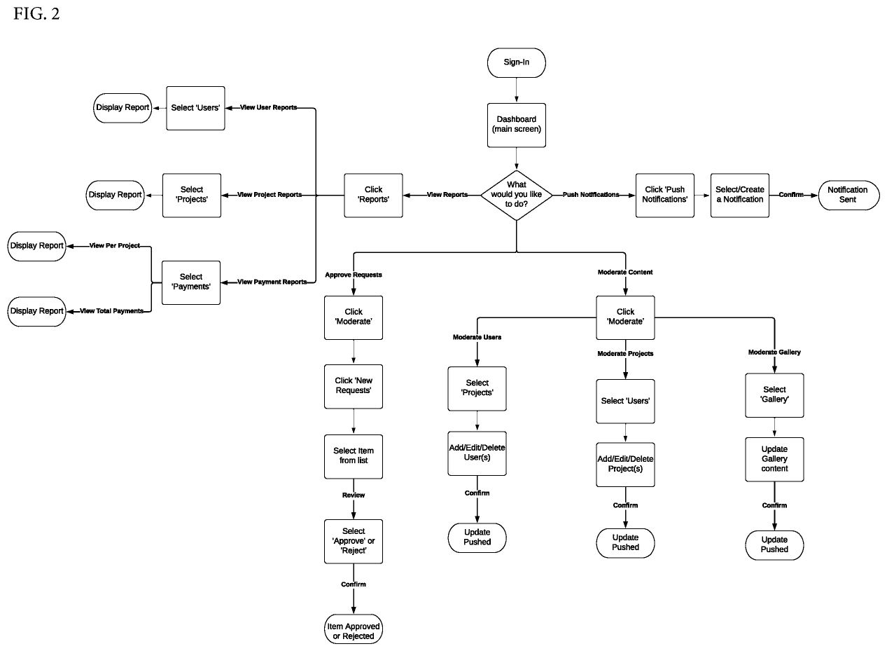

FIG. 2: This figure shows the flow of the mobile application now named the ARTWYRX app from the Administrator perspective. The Administrator has the ability to admit or deny project requests and admit or deny collaborator requests. The Administrator can also update information posted in the Gallery, where collaborators can post art to share and/or sell. The Administrator can view reports with information regarding specified activity of payments, projects, and users (collaborators) and can send notifications to collaborators. A dashboard provides an interface for the site administrator to perform these tasks.

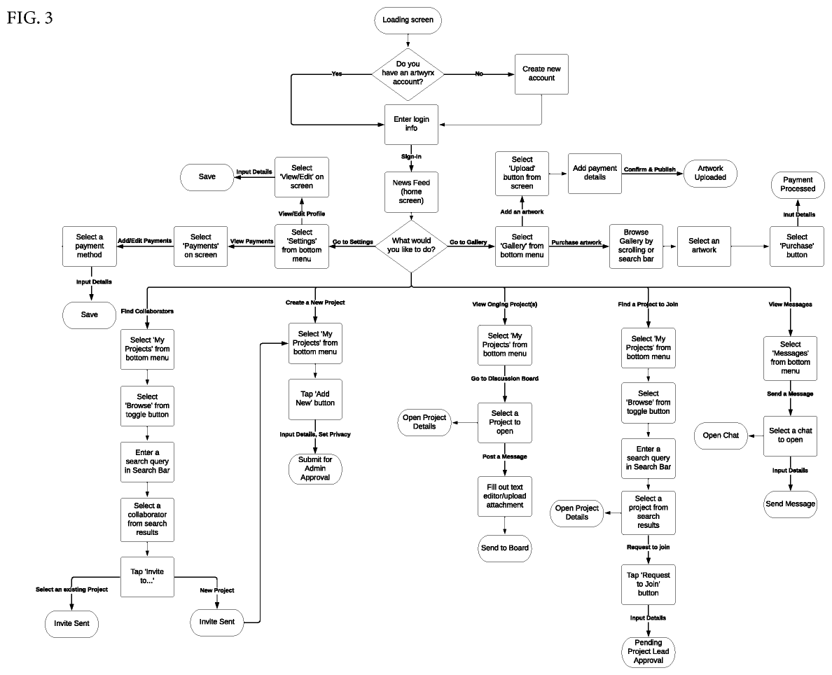

FIG. 3: This figure shows the flow of the mobile application now named the ARTWYRX app from the User perspective. The user can create a profile, can create a project, can enter payment details, can upload art to the Gallery, can view public projects on the platform, can view projects they belong to, can message other user profiles on the site, and can request to join projects.

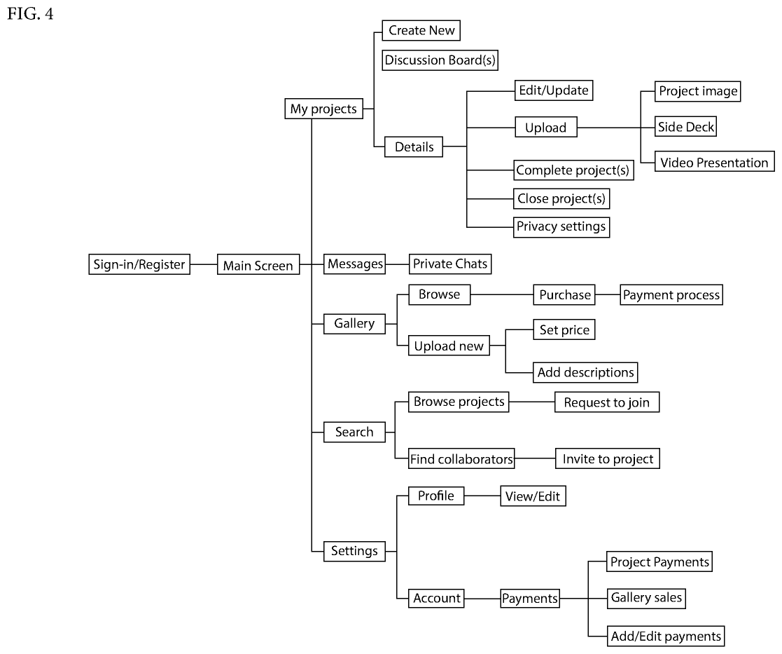

FIG. 4: This figure shows a sitemap of the application. After registration and sign-in the main screen has buttons to view “My Projects” (a list of the collaborator's projects), a Message icon, a Gallery icon, an ability to search for projects and collaborators, an icon to access Settings, and an icon to access Payments. Messages are private chats between profile users. A registered collaborator can create a project; within the project is a discussion board accessible to admitted collaborators. The project has upload space for an image, a video and/or a slide deck (PDF format). The collaborator can edit/update this information and can mark the project as complete, and/or close the project. Within the Gallery, the collaborator can browse art, purchase art, can upload new art, can set prices and enter a text description of the art piece. Within search the collaborator can search other collaborators by an @ handle, name, location, skill or information entered in the experience text box. The collaborator who registered a project as a project lead can invite selected collaborators to join the project. A collaborator can also search projects by location, genre, skill, location, and information entered in the text description field and request to join selected project.

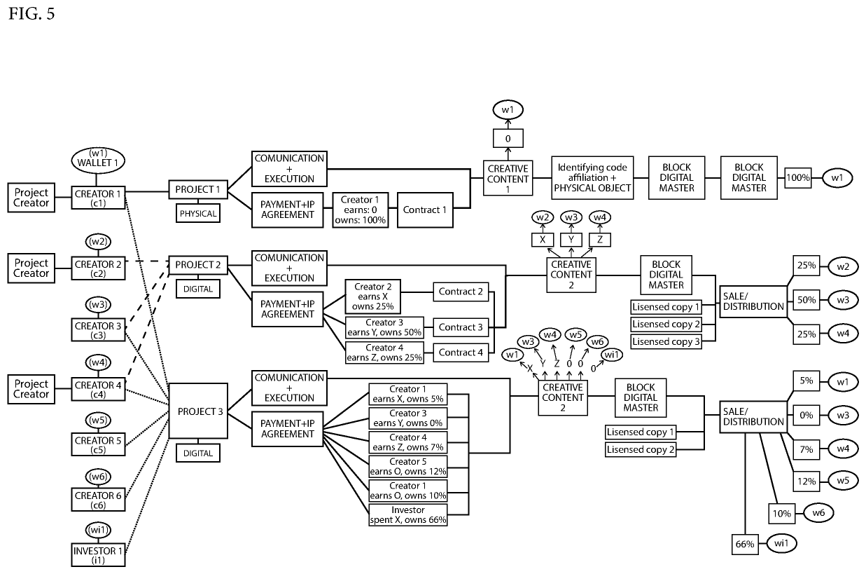

FIG. 5: This embodiment of the current invention illustrates the process of recording intellectual property smart contracts for creative projects involving both teams and individuals. The project creator has either one creator attached to the project or multiple creators attached to the project. Each creator has a unique and secure digital wallet associated with the their identity. The project can be either digital (such as a video file) or physical (such as a painting) with an associated unique identifier. The platform project management information is represented by the communicate and execution box. Here instructions regarding the creation of the project are executed and agreements are negotiated regarding intellectual property rights and ownership percentages. These are encoded into a ledger so that the payment information and the intellectual property agreement (the contract) is embedded onto a unique blockchain which contains within it the actual digital creative project (for example, if it is a video file) or the unique code associated with the physical object (if it is a painting). Both current payments for work executed on the project and future payments in the form of residuals regarding shares and/or percentage ownership of the project are encoded on the ledger and affixed to the unique blockchain associated with the project. The creative content thus carries within it information regarding who worked on the project, how much they were paid and what percentage ownership they will receive in future payments due to sales and/or distribution. The creative project is always issued as a unique digital master on a blockchain for unique ownership and licensed copies also on a blockchain are made for distribution. The licensed copies and the block digital master all contain the identical information regarding payments and ownership. When a sale and/or authorized distribution occurs the smart contract payment system is executed and payments are disbursed to the associated digital wallets of the creators. Investors can also have a wallet issued and receive percentage ownership and residuals from profits in the same fashion as a creator.

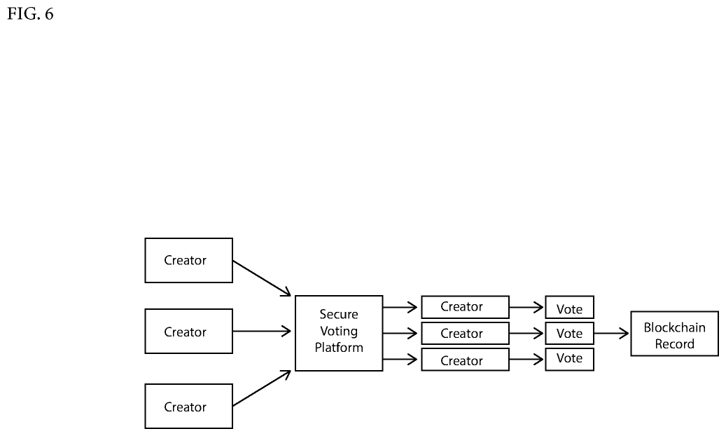

FIG. 6: This embodiment illustrates an embodiment of the invention regarding a voting system for a de-centralized autonomous organization wherein creators as a conglomerate of creators can make crucial decisions about the protocol and its operation as a platform. Each creator accesses a secure voting platform where they vote on issues that affect the operation of both the platform and the protocol on which it is based and the tallied result is recorded on a blockchain record accessible to the creators.

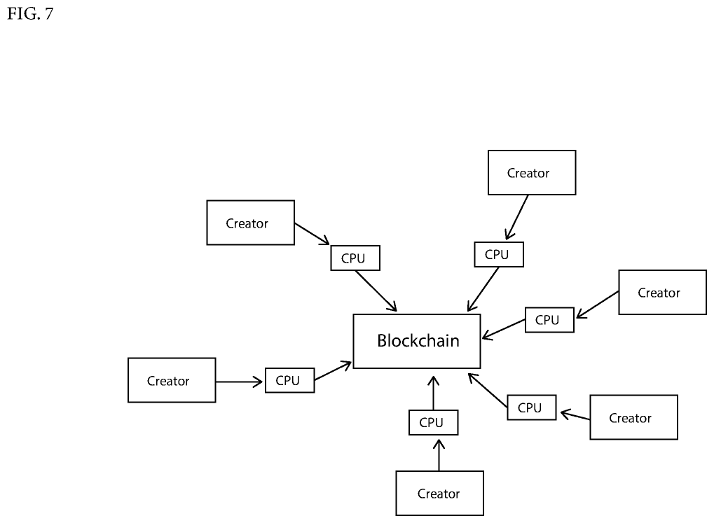

FIG. 7: This figure illustrates an embodiment of the manner in which Central Processing Units (CPU's) can be networked to power the creation of blockchains used by the platform using the combined processing power contributed by creators on the platform.

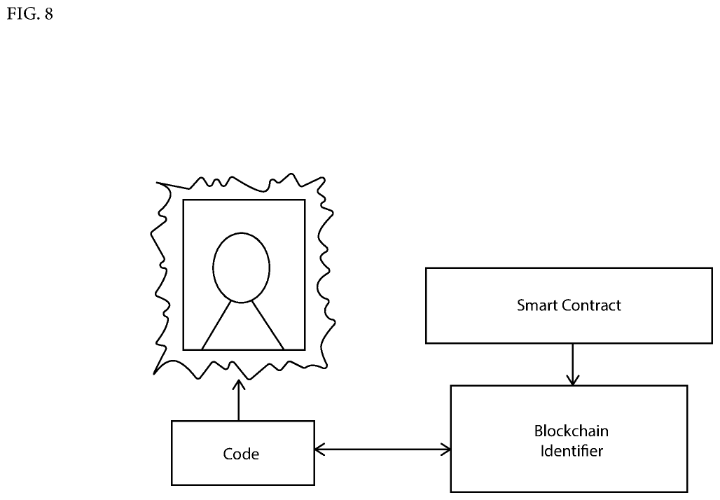

FIG. 8: This figure illustrates an embodiment of the invention which assigns a unique code (such as a QR code but includes any similar associated identifier) that can be affixed to a physical creative and/or artistic object and that code references a unique blockchain identifier that is linked to a smart contract. The smart contract, for example, may have encoded information to provide a percentage of sales and resales to the original artist. Thus every time the physical object is sold and/or resold the intellectual property rights will follow the object and execute payments of contracts detailed in the smart contract and connected to the blockchain identifier and the associated digital wallet of the creator (artist).

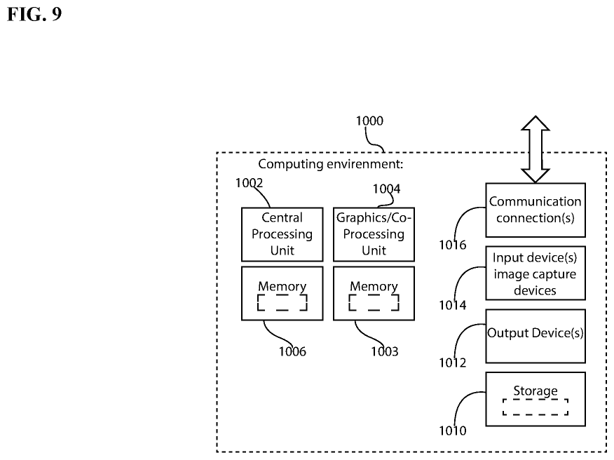

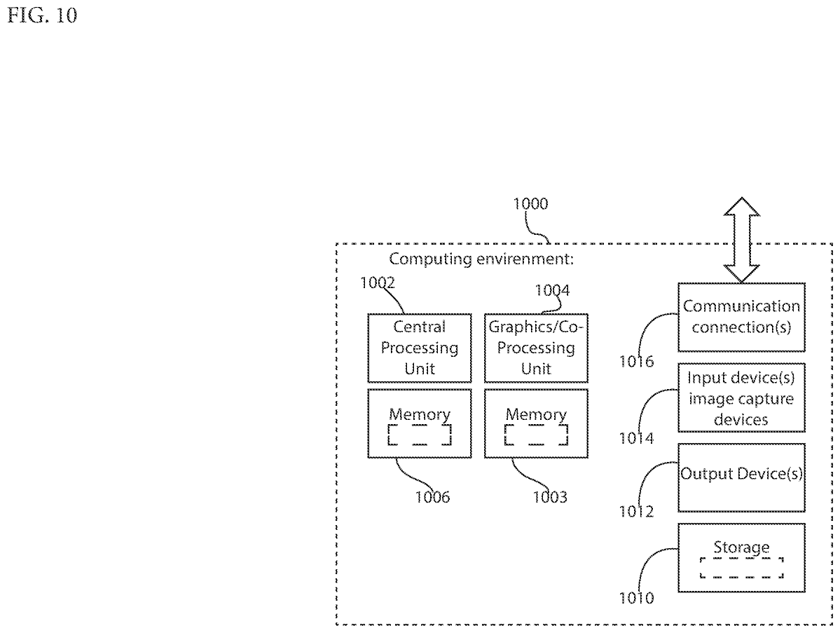

FIG. 9 attached illustrates a block diagram of hardware that may be employed in an implementation of the embodiments disclosed herein. FIG. 9 depicts a generalized example of a suitable general-purpose computing system 1000 in which the described innovations may be implemented in order to improve the processing speed and efficiency with which the computing system 1000 operates to perform the functions disclosed herein. With reference to FIG. 9 the computing system 1000 includes one or more processing units 1002, 1004 and memory 1006, 1008. The processing units 1002, 1006 execute computer-executable instructions. A processing unit can be a general-purpose central processing unit (CPU), processor in an application-specific integrated circuit (ASIC) or any other type of processor. The tangible memory 1006, 1008 may be volatile memory (e.g., registers, cache, RAM), non-volatile memory (e.g., ROM, EEPROM, flash memory, etc.), or some combination of the two, accessible by the processing unit(s). The hardware components in FIG. 9 may be standard hardware components, or alternatively, some embodiments may employ specialized hardware components to further increase the operating efficiency and speed with which the system 10 operates. The various components of computing system 1000 may be rearranged in various embodiments, and some embodiments may not require nor include all of the above components, while other embodiments may include additional components, such as specialized processors and additional memory.

Computing system 1000 may have additional features such as for example, storage 1010, one or more input devices 1014, one or more output devices 1012, and one or more communication connections 1016. An interconnection mechanism (not shown) such as a bus, controller, or network interconnects the components of the computing system 1000. Typically, operating system software (not shown) provides an operating system for other software executing in the computing system 1000, and coordinates activities of the components of the computing system 1000.

The tangible storage 1010 may be removable or non-removable, and includes magnetic disks, magnetic tapes or cassettes, CD-ROMs, DVDs, or any other medium which can be used to store information in a non-transitory way, and which can be accessed within the computing system 1000. The storage 1010 stores instructions for the software implementing one or more innovations described herein.

The input device(s) 1014 may be a touch input device such as a keyboard, mouse, pen, or trackball, a voice input device, a scanning device, or another device that provides input to the computing system 1000. For video encoding, the input device(s) 1014 may be a camera, video card, TV tuner card, or similar device that accepts video input in analog or digital form, or a CD-ROM or CD-RW that reads video samples into the computing system 1000. The output device(s) 1012 may be a display, printer, speaker, CD-writer, or another device that provides output from the computing system 1000.

The communication connection(s) 1016 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

The terms “system” and “computing device” are used interchangeably herein. Unless the context clearly indicates otherwise, neither term implies any limitation on a type of computing system or computing device. In general, a computing system or computing device can be local or distributed and can include any combination of special-purpose hardware and/or general-purpose hardware with software implementing the functionality described herein.

The details and implementations described herein can be combined in one software package or packaged into multiple software products. Other implementations are in the scope of the claims. Operations described are in no particular order or in sequential order and can be achieved in part, in parallel, in a different order and still achieve desired results.

1. A computerized method for managing development of a creative project, comprising:
accepting inputs from a first user to establish a creator profile;
accepting inputs from the first user to generate a creative project associated with the creator profile;
identifying to the first user one or more other users as candidates to provide inputs to the creative project;
accepting inputs from the first user to cause one or more payments to be credited to the one or more other users; and
issuing the creative project to a distributed ledger in the form of a blockchain.

2. The computerized method of claim 1 further comprising:
generating a proof-of-work blockchain certificate for the creative project wherein the proof-of-work blockchain certificate includes a proof-of-stake smart contract containing intellectual property and payment information.

3. The computerized method of claim 2 further comprising:
associating a wallet, with the first user, encoded on the smart contract to facilitate rights execution of the smart contract.
